(19) United States
(12) Patent Application Publication
(10) Pub. No.: US 2013/0237089 A1
(43) Pub. Date: Sep. 12, 2013

(54) COAXIAL CABLE CONNECTOR USING A MULTI-CONTACT SPRING WASHER

(71) Applicant: Yueh Chiung LU, Ta Yuen Hsiang (TW)

(72) Inventor: Yueh Chiung LU, Ta Yuen Hsiang (TW)

(21) Appl. No.: 13/412,972

(22) Filed: Mar. 6, 2012

(51) Int. Cl. H01R 9/05

(52) U.S. Cl. 439/578

(57) ABSTRACT

A coaxial cable connector for connecting a coaxial cable to a mating device is disclosed to include a locknut, a connector body consisting of an inner tube, a body shell, a barrel and a plastic bushing, a multi-contact spring washer, and an O-ring. The multi-contact spring washer is mounted on a front neck of the body shell, having three or more equiangularly spaced first contact points kept in contact with an annular rear contact face of the locknut and three or more equiangularly spaced second contact points kept in contact with the annular front stop face of the body shell, ensuring positive grounding and enhancing signal transmission reliability.

### BACKGROUND OF THE INVENTION

1. Field of the Invention

The present invention relates to coaxial cable connectors and more particularly, to a coaxial cable for connecting a coaxial cable to a mating device, for example, cable TV distributor or set-top box, which uses a multi-contact spring washer to work with a locknut, ensuring positive grounding and enhancing signal transmission reliability.

2. Description of the Related Art

U.S. patent Ser. No. 13/274,308, invented by the present inventor, discloses a coaxial cable connector suitable for assembly with one of a series of coaxial cables having one same specification and different wire outer diameters, which uses a plastic bushing for compressing by a barrel to wrap about the coaxial cable and compress an inner tube against the aluminum foil and insulation spacer of the coaxial cable, protecting the coaxial cable against weather and extending the lifespan, an O-ring in a locating groove around a front neck of a body shell or on an annular rear contact face of a locknut to seal the gap between the locknut and the body shell, and a curved spring plate for stoppage between an annular front stop face of the body shell and an annular rear contact face of the locknut for grounding to enhance signal transmission reliability.

In the aforesaid prior art design, the curved spring plate has a substantially “8” shape profile when viewed from one lateral side. After installation, the curved spring plate provides two contact points between the body shell and the locknut. As this structure simply provides two contact points between the body shell and the locknut, the locknut may be not positively stopped against the inner tube in one of certain angles after installation of the F-connector of the mating device, resulting in signal transmission instability.

### SUMMARY OF THE INVENTION

The present invention has been accomplished under the circumstances in view. It is main object of the present invention to provide a coaxial cable connector for assembly with one of a series of coaxial cables having one same specification and different wire outer diameters, which eliminates the drawbacks of the aforesaid various prior art designs.

To achieve this and other objects of the present invention, a coaxial cable connector connecting a coaxial cable having a center conductor to a mating device having an F-connector is disclosed. The coaxial cable connector comprises a locknut, a connector body, a multi-contact spring washer and an O-ring. The locknut comprises an inner thread for threading onto an outer thread of the F-connector of the mating device, a vertically extending annular rear contact face disposed at a rear side thereof, a horizontally extending tubular rear inner face, an inside stop face perpendicularly extended from a front side of the horizontally extending tubular rear inner face in a parallel manner relative to the vertically extending annular rear contact face, and an inside annular groove defined between the vertically extending annular rear contact face and the horizontally extending tubular rear inner face. The connector body consists of an inner tube, a body shell, a barrel and a plastic bushing, and is fastened to one end of the coaxial cable to keep the center conductor of the coaxial cable suspend in the locknut, the connector body, the inner tube being mounted in one end of the locknut and comprising an annular front end face radially outwardly extended from the front side thereof and an annular front stop face disposed in a parallel manner at a back side of the annular front end face, the body shell comprising a clamping hole axially extending through opposing front and rear sides thereof and wrapping about the inner tube, an annular front stop face vertically disposed at the front side, a front neck axially forwardly disposed at the front side around the clamping hole and a tapered face connected between the front neck and the annular front stop face. The multi-contact spring washer is mounted on the front neck of the body shell, comprising at least three equiangularly spaced first contact points kept in contact with the annular rear contact face of the locknut. The O-ring is mounted in the inside annular groove of the locknut and stopped against the periphery of the front neck of the body shell to seal the gap between the locknut and the front neck of the body shell.

Further, the multi-contact spring washer further comprises and at least three equiangularly spaced second contact points kept in contact with the annular front stop face of the body shell.

Further, the multi-contact spring washer further comprises a plurality of first oblique washer body portions and a plurality of second oblique washer body portions alternatively connected in an endless series and respectively sloping in reversed directions. The at least three equiangularly spaced first contact points and the at least three equiangularly spaced second contact points are respectively disposed at the connections between the first oblique washer body portions and the second oblique washer body portions and arranged at two opposite sides.

Alternatively, the multi-contact spring washer further comprises a plurality of planar body portions selectively connected between the first oblique washer body portions and the second oblique washer body portions to form the at least three equiangularly spaced first contact points.

Alternatively, the multi-contact spring washer further comprises a plurality of planar body portions respectively connected between the first oblique washer body portions and the second oblique washer body portions to form the at least three equiangularly spaced first contact points and the at least three equiangularly spaced second contact points.

Alternatively, the multi-contact spring washer comprises an annular spring washer body, and at least three lugs equiangularly protruded from one side of the annular spring washer body to form the at least three equiangularly spaced first contact points.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a coaxial cable connector in accordance with the present invention.

FIG. 2 is an elevational assembly view of the coaxial cable connector in accordance with the present invention.

FIG. 3 is a sectional view of the present invention, illustrating the coaxial cable connector fastened to a coaxial cable.

FIG. 4 is an enlarged view of part A of FIG. 3.

FIGS. 5A˜5C are elevational side, side view and plain view of a first example of the multi-contact spring washer in accordance with the present invention.

FIGS. 6A˜6C are elevational side, side view and plain view of a second example of the multi-contact spring washer in accordance with the present invention.

FIGS. 7A˜7C are elevational side, side view and plain view of a third example of the multi-contact spring washer in accordance with the present invention.

FIGS. 8A˜8C are elevational side, side view and plain view of a fourth example of the multi-contact spring washer in accordance with the present invention.

### DETAILED DESCRIPTION OF THE PREFERRED EMBODIMENT

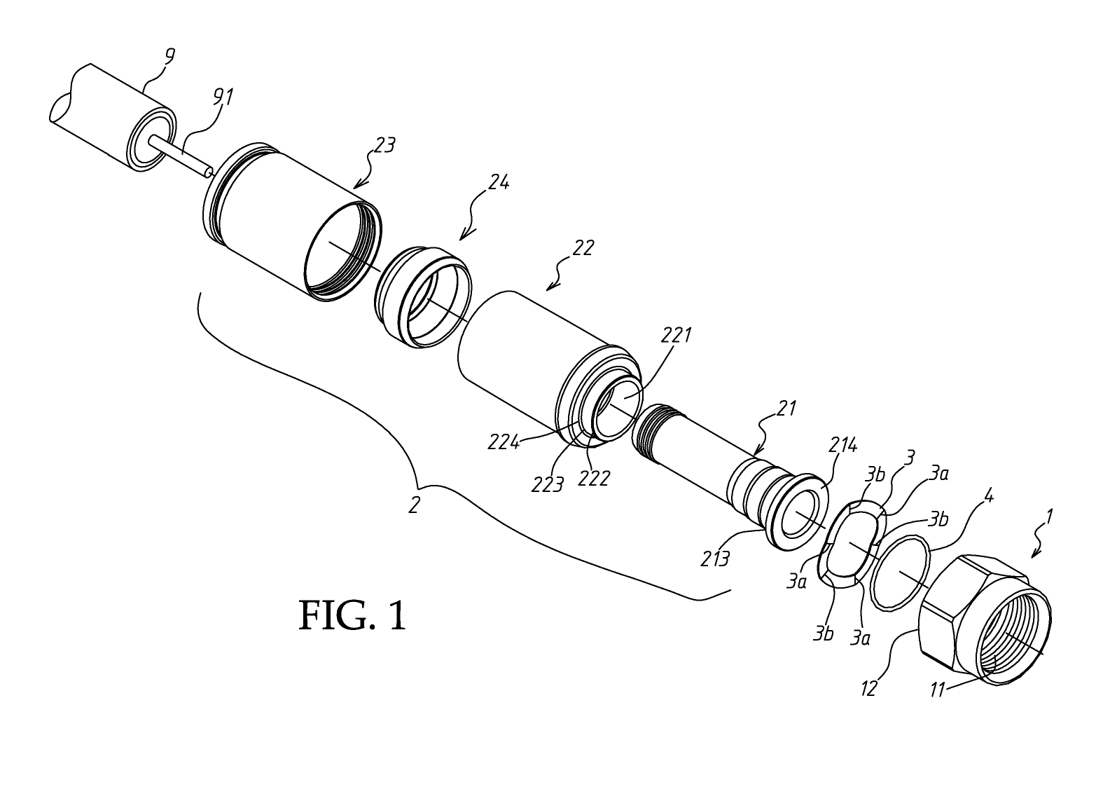

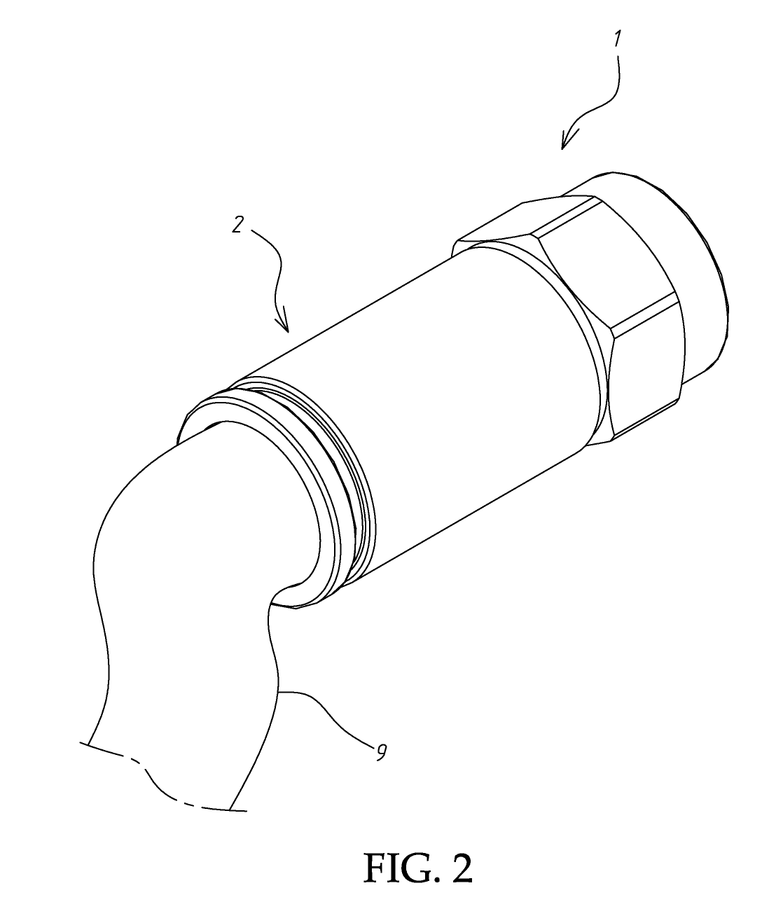

Referring to FIGS. 1-3, a coaxial cable connector in accordance with the present invention is adapted for connecting a coaxial cable 9 having a center conductor 91 to a mating device (not shown). The coaxial cable connector comprises a locknut 1, a connector body 2, a multi-contact spring washer 3, and an O-ring 4.

Similar to the design of U.S. patent Ser. No. 13/274,308, the connector body 2 consists of an inner tube 21, a body shell 22, a barrel 23 and a plastic bushing 24. However, this design of connector body is not a limitation, i.e., the connector body may be variously embodied for connecting a coaxial cable.

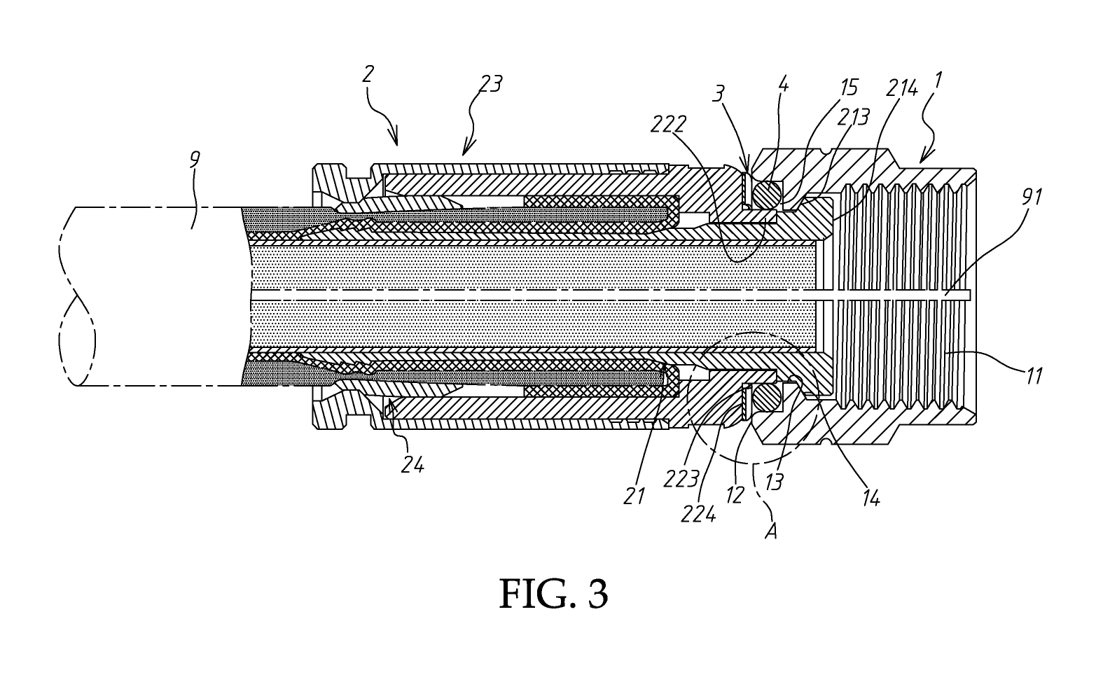

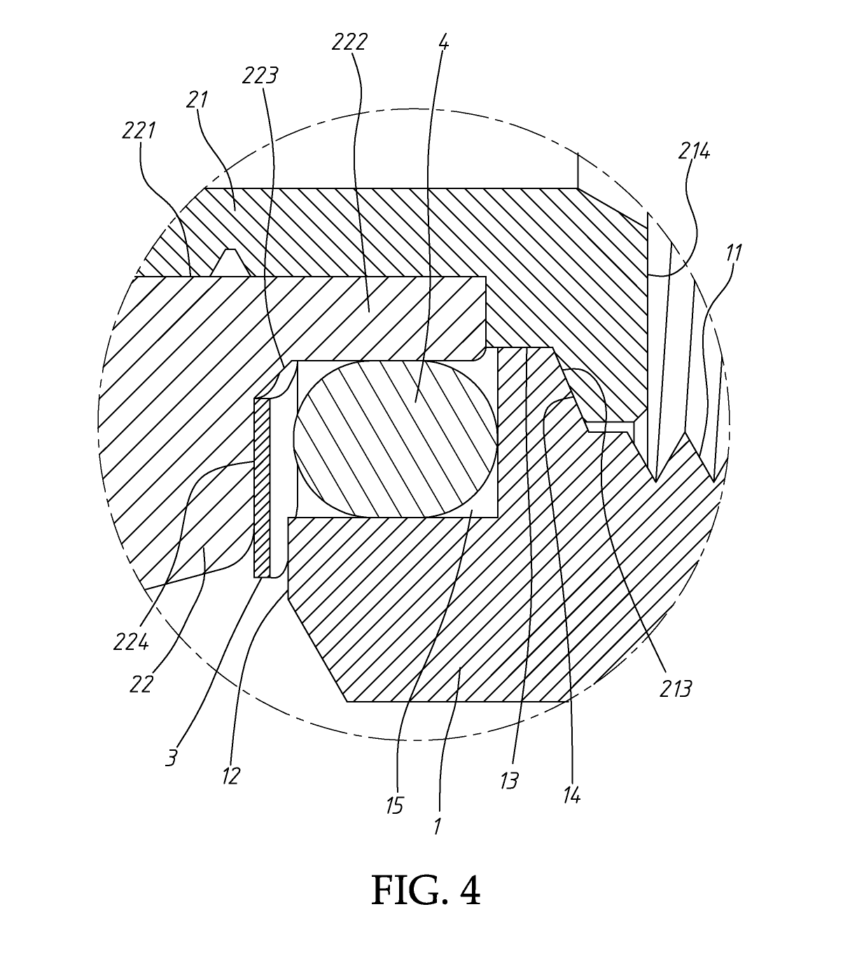

The locknut 1 comprises an inner thread 11 for threading onto an outer thread of a F-connector of a mating device (not shown), a vertically (radially) extending annular rear contact face 12 disposed at the rear side thereof, as shown in FIGS. 3 and 4, a horizontally (axially) extending tubular rear inner face 13, an inside stop face 14 perpendicularly extended from the front side of the horizontally (axially) extending tubular rear inner face 13 in a parallel manner relative to the vertically (radially) extending annular rear contact face 12, and an inside annular groove 15 defined between the vertically (radially) extending annular rear contact face 12 and the horizontally (axially) extending tubular rear inner face 13.

The connector body 2 is fastened to one end of the coaxial cable 9, enabling the center conductor 91 of the coaxial cable 9 to suspend in the locknut 1. As stated above, the connector body 2 consists of an inner tube 21, a body shell 22, a barrel 23 and a plastic bushing 24, wherein the barrel 23 and the plastic bushing 24 are same or similar to the corresponding barrel and plastic bushing of the design of U.S. patent Ser. No. 13/274,308.

The inner tube 21 is mounted in one end of the locknut 1, comprising an annular front end face 214 radially outwardly extended from the front side thereof, and an annular front stop face 213 disposed in a parallel manner at the back side of the annular front end face 214. The body shell 22 surrounds the inner tube 21. comprising a clamping hole 221 axially extending through opposing front and rear sides thereof, an annular front stop face 224 vertically (radially) disposed at the front side, a front neck 222 axially forwardly disposed at the front side around the clamping hole 221, and a tapered face 223 connected between the front neck 222 and the annular front stop face 224.

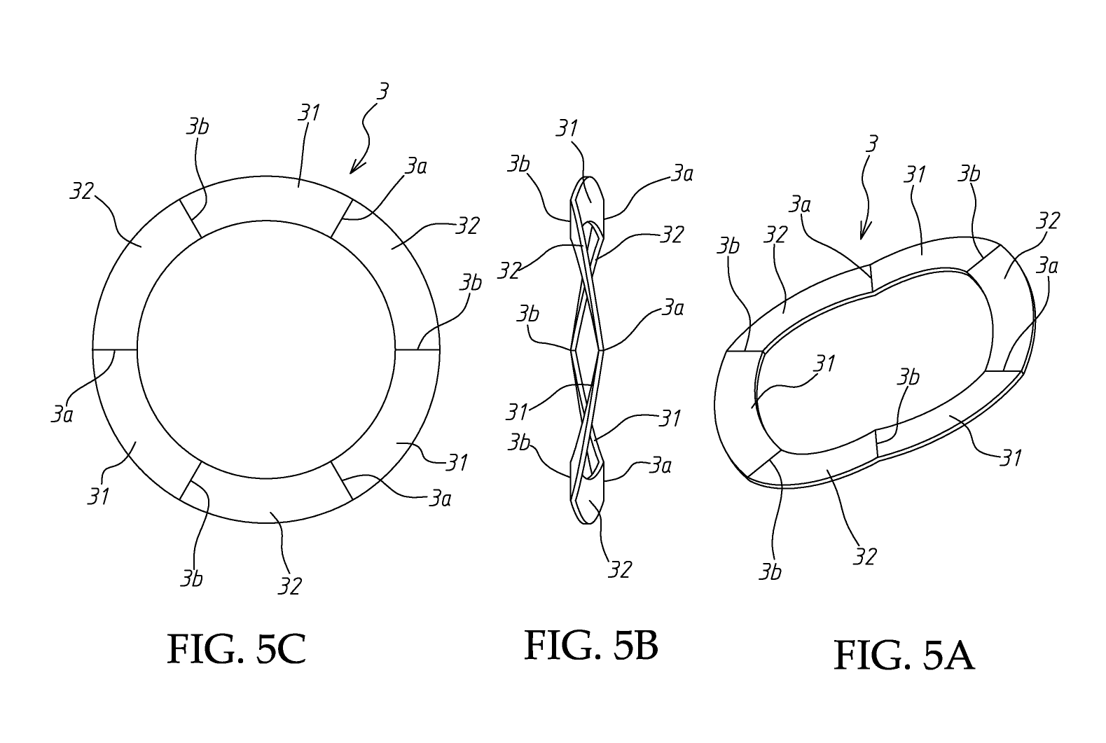

The main feature of the present invention is the design of the multi-contact spring washer 3. The multi-contact spring washer 3 is mounted on the front neck 222 of the body shell 22 and kept in contact with the annular rear contact face 12 of the locknut 1 at three or more first contact points 3a thereof, and also kept in contact with the annular front stop face 224 of the body shell 22 at three or more second contact points 3b thereof. In accordance with a first example of the present invention, as illustrated in FIGS. 5A-5C, multi-contact spring washer 3 comprises a plurality of first oblique washer body portions 31 and a plurality of second oblique washer body portions 32 alternatively connected in an endless series and respectively sloping in reversed directions, defining the first contact points 3a and the second contact points 3b at the junctions between each two adjacent ones of the first oblique washer body portions 31 and second oblique washer body portions 32. The first contact points 3a and the second contact points 3b are alternatively disposed at two opposite sides of the multi-contact spring washer 3.

Subject to the aforesaid design of multi-contact spring washer 3, the annular rear contact face 12 of the locknut 1 is kept in contact with the three or more first contact points 3a. Thus, when threading the locknut 1 onto the outer thread of the F-connector of the mating device, the inside stop face 14 of the locknut 1 is constantly kept in positive contact with the annular front stop face 213 of the inner tube 21 to provide excellent grounding, assuring optimal signal transmission between the coaxial cable and the mating device.

Further, the O-ring 4 is mounted in the inside annular groove 15 of the locknut 1 and stopped against the periphery of the front neck 222 of the body shell 22 to seal the gap between the locknut 1 and the front neck 222 of the body shell 22, providing excellent waterproof function.

As the multi-contact spring washer 3 has the three or more first contact points 3a thereof constantly kept in contact with the annular rear contact face 12 of the locknut 1, the inside stop face 14 of the locknut 1 is constantly kept in positive contact with the annular front stop face 213 of the inner tube 21 when the locknut 1 is rotated to any particular angle relative to the F-connector of the mating device, eliminating the problem of signal transmission interruption of the prior art design upon rotation of the locknut to a particular angle relative to the F-connector of the mating device.

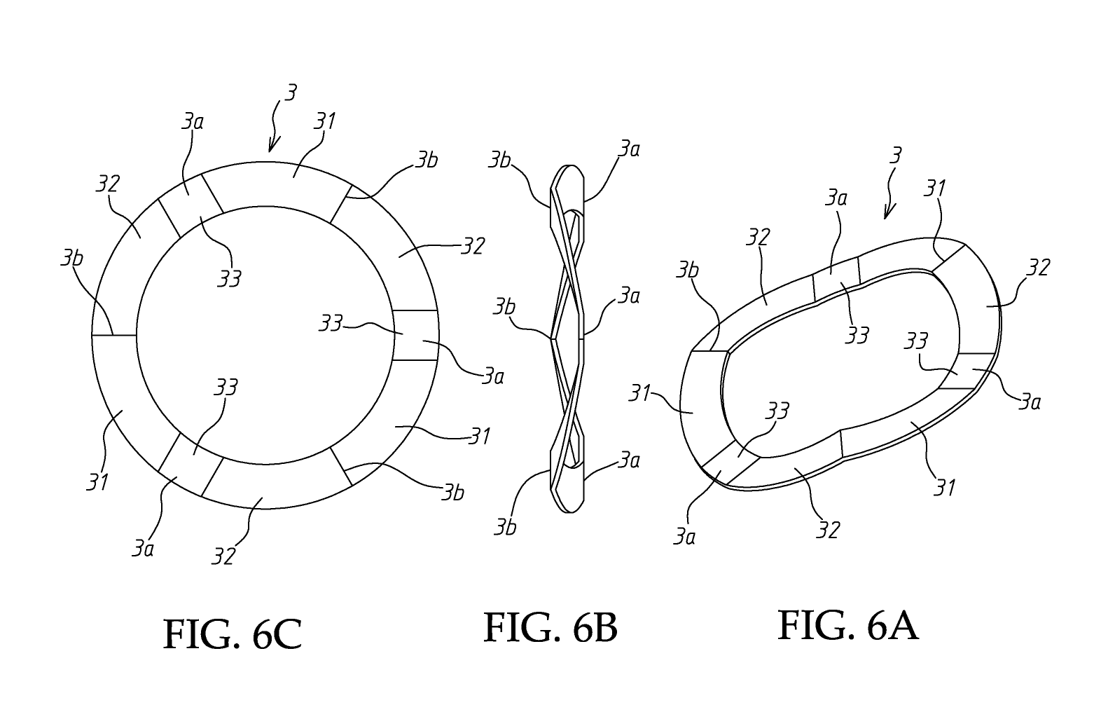

FIGS. 6A˜6C illustrate a second example of the multi-contact spring washer 3. This second example is substantially similar to the aforesaid first example with the exception that the multi-contact spring washer 3 of this second example further comprises a plurality of planar body portions 33 selectively connected between the first oblique washer body portions 31 and the second oblique washer body portions 32, defining the first contact points 3a. Thus, the contact area between the first contact points 3a and the annular rear contact face 12 of the locknut 1 is relatively increased, keeping the locknut 1 in positive contact with the inner tube 21.

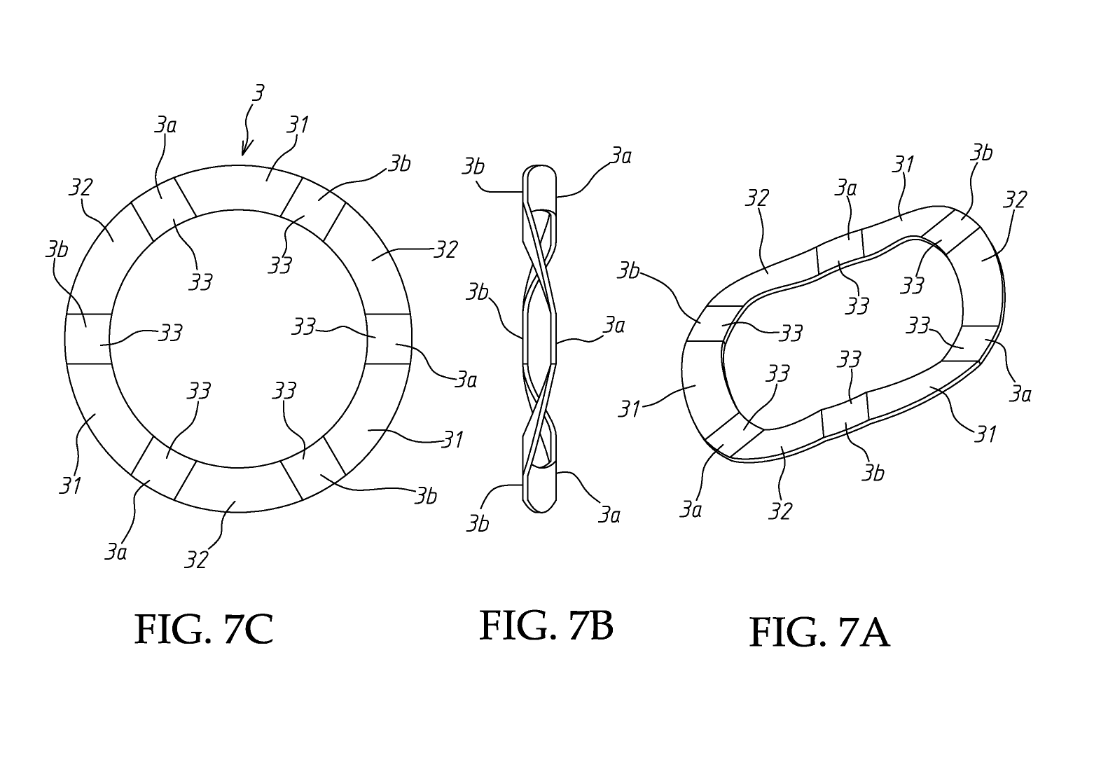

FIGS. 7A˜7C illustrate a third example of the multi-contact spring washer 3. This third example is substantially similar to the aforesaid first example with the exception that the multi-contact spring washer 3 of this third example further comprises a plurality of planar body portions 33 respectively connected between the first oblique washer body portions 31 and the second oblique washer body portions 32, defining the first contact points 3a and the second contact points 3b. Thus, the contact area between the first contact points 3a and the annular rear contact face 12 of the locknut 1 and the contact area between the second contact points 3b and the annular front stop face 224 of the body shell 22 are relatively increased, keeping the locknut 1 in positive contact with the inner tube 21.

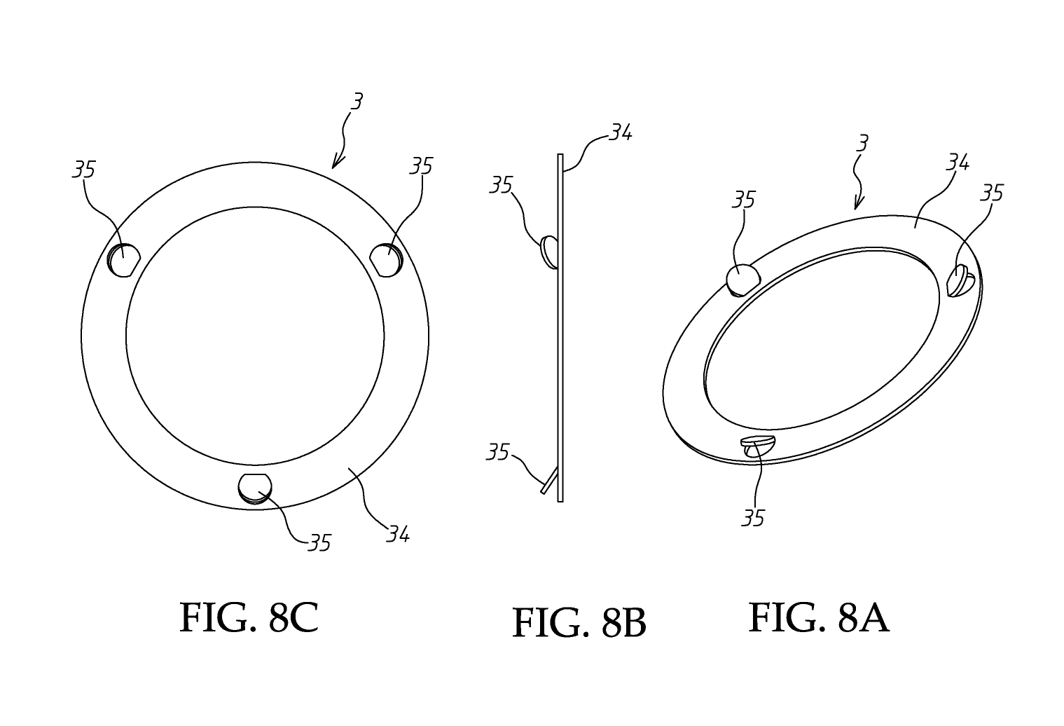

FIGS. 8A˜8C illustrate a fourth example of the multi-contact spring washer 3. According to this fourth example, the multi-contact spring washer 3 comprises an annular spring washer body 34 and at least three lugs 35 equiangularly protruded from one side of the annular spring washer body 34. The lugs 35 are formed of a part of the annular spring washer body 34 by stamping. This fourth example has the advantages of ease of fabrication and low manufacturing cost.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A coaxial cable connector connecting a coaxial cable having a center conductor to a mating device having a F-connector, said coaxial cable connector comprising:
a locknut comprising an inner thread for threading onto an outer thread of said F-connector of said mating device, a vertically extending annular rear contact face disposed at a rear side thereof, a horizontally extending tubular rear inner face, an inside stop face perpendicularly extended from a front side of said horizontally extending tubular rear inner face in a parallel manner relative to said vertically extending annular rear contact face, and an inside annular groove defined between said vertically extending annular rear contact face and said horizontally extending tubular rear inner face;
a connector body consisting of an inner tube, a body shell, a barrel and a plastic bushing and fastened to one end of said coaxial cable to keep said center conductor of said coaxial cable suspend in said locknut, said connector body, said inner tube being mounted in one end of said locknut and comprising an annular front end face radially outwardly extended from the front side thereof and an annular front stop face disposed in a parallel manner at a back side of said annular front end face, said body shell comprising a clamping hole axially extending through opposing front and rear sides thereof and wrapping about said inner tube, an annular front stop face vertically disposed at the front side, a front neck axially forwardly disposed at the front side around said clamping hole and a tapered face connected between said front neck and said annular front stop face;
a multi-contact spring washer mounted on said front neck of said body shell, said multi-contact spring washer comprising at least three equiangularly spaced first contact points kept in contact with said annular rear contact face of said locknut; and
an O-ring mounted in said inside annular groove of said locknut and stopped against the periphery of said front neck of said body shell to seal the gap between said locknut and said front neck of said body shell.

2. The coaxial cable connector as claimed in claim 1, wherein said multi-contact spring washer further comprises and at least three equiangularly spaced second contact points kept in contact with said annular front stop face of said body shell.

3. The coaxial cable connector as claimed in claim 2, wherein said multi-contact spring washer further comprises a plurality of first oblique washer body portions and a plurality of second oblique washer body portions alternatively connected in an endless series and respectively sloping in reversed directions; said at least three equiangularly spaced first contact points and said at least three equiangularly spaced second contact points being respectively disposed at the connections between said first oblique washer body portions and said second oblique washer body portions and arranged at two opposite sides.

4. The coaxial cable connector as claimed in claim 3, wherein said multi-contact spring washer further comprises a plurality of planar body portions selectively connected between said first oblique washer body portions and said second oblique washer body portions to form said at least three equiangularly spaced first contact points.

5. The coaxial cable connector as claimed in claim 3, wherein said multi-contact spring washer further comprises a plurality of planar body portions respectively connected between said first oblique washer body portions and said second oblique washer body portions to form said at least three equiangularly spaced first contact points and said at least three equiangularly spaced second contact points.

6. The coaxial cable connector as claimed in claim 3, wherein said multi-contact spring washer further comprises an annular spring washer body, and at least three lugs equiangularly protruded from one side of said annular spring washer body to form said at least three equiangularly spaced first contact points.
